(19) United States
(12) Patent Application Publication
(10) Pub. No.: US 2001/0024066 A1
(43) Pub. Date: Sep. 27, 2001

(54) Handheld device, smart card interface device (IFD) and data transmission method

(75) Inventors: RongYao Fu, Beijing (CN); Jun Shen, Beijing (CN); JingMin Xu, Beijing (CN); Song Song, Beijing (CN)

Correspondence Address: Louis P. Herzberg, IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/761,053

(22) Filed: Jan. 16, 2001

(30) Foreign Application Priority Data
Jan. 20, 2000 (JP) 00101607.5

(51) Int. Cl. H01H 35/00

(52) U.S. Cl. 307/116; 307/134; 361/149

(57) ABSTRACT

A smart card interface device which can be installed in an expansion slot of a handheld device comprises: a host interface unit for connecting with I/O ports included in the expansion slot of the handheld device so as to receive/send serial communication data signals and clock signals from/to said I/O ports; a first smart card connector provided at a surface of said smart card interface device, for electrically connecting with a smart card of the first type; a first smart card interface unit for detecting whether a smart card of the first type has been connected to said first smart card connector and for driving the smart card of the first type being connected; a protocol implementation unit for controlling each component of said smart card interface device so as to implement communication protocols between said smart card interface device and said handheld device as well as between said smart card interface device and said smart card of the first type.

The present invention relates to handheld devices,the smart card interface devices for handheld devices and method of data transmission with handheld devices. In particular, the present invention relates to smart card-enabled handheld devices, smart card interface devices which can be installed in the expansion slots of handheld devices, and method of data transmission with handheld devices by using expansion slots of handheld devices.

More and more different kinds of handheld devices are increasingly emerging today, among which 3COM's PalmPilot and IBM's WorkPad are more popular. The surge of the handheld devices makes the dreams of extending IT services to the tens of millions of mobile users become possible. However, poor CPU power and small storage have set a lot of limitations on handheld devices when they are used in the field of e-business , because it can't solve the problem of security . In addition, the data residing in the memory of handheld devices is volatile when the batteries are exhausted or some accidents take place. It's unsafe to hold permanent, important personal information on handheld devices. However, some important information(e.g. the key of a cryptographic algorithm) is necessary in most security system of the handheld devices.

The resource limitations make handheld device can not provide some necessary capabilities required by most security system,such as data encryption/decryption,the safe storage for local data,etc. These capabilities can be provided by smart cards that have been used broadly. There are two different kinds of smart cards in size. One has the same size as a credit card, and another has a smaller size,which is referred to as SIM card. Smart card is generally used to hold some important information (e.g. the cypher key, personal identification, etc.) or to provide some specific funcitonalities by executing some complex programs. For instance, the security card will provide some cryptographic algorithms, and the Java card can run Java applets.

The combination of smart cards and handheld devices must greatly improve the capability of handheld devices and result in the expansion of the application field of the handheld devices. The present invention addresses the problems on the combination of smart cards and handheld devices.

The first object of the present invention is to provide a smart card interface device that can be installed in an expansion slot of a handheld device.

The second object of the present invention is to provide a smart card enabled handheld device.

The third object of the present invention is to provide a method of sending data from a handheld device by using an expansion slot of said handheld device.

The fourth object of the present invention is to provide a method of receiving data from a handheld device by using an expansion slot of said handheld device.

The fifth object of the present invention is to provide a method for controlling the power supply of a smart card interface device within a handheld device.

To reach the first object, the present invention provides a smart card interface device that can be installed in an expansion slot of a handheld device, characterized by comprising:

a host interface unit for connecting with I/O ports included in the expansion slot of the handheld device so as to receive/send serial communication data signals and clock signals from/to said I/O ports;

a first smart card connector provided at a surface of said smart card interface device, used for electrically connecting with a smart card of a first type;

a first smart card interface unit for detecting whether a smart card of the first type has been connected to said first smart card connector and for driving the smart card of the first type being connected;

a protocol implementation unit for controlling each components of said smart card interface device so as to implement communication protocols between said smart card interface device and said handheld device as well as communication protocols between said smart card interface device and said smart card of the first type.

To reach the second object, the present invention provides a handheld device with an expansion slot that contains I/O ports. Said handheld device comprises:

means for driving the I/O ports.

means for receiving/sending serial communication data signals and clock signals from/to said I/O ports

a smart card interface device connected with said expansion slot, characterized by comprising:

a host interface unit for connecting with I/O ports so as to receive/send serial communication data signals and clock signals from/to said I/O ports.

a first smart card connector provided at a surface of said smart card interface device, used for electrically connecting with a smart card of a first type;

a first smart card interface unit for detecting whether a smart card of the first type has been connected to said first smart card connector and for driving the smart card of the first type being connected;

a protocol implementation unit for controlling each components of said smart card interface device so as to implement communication protocols between said smart card interface device and said handheld device as well as communication protocols between said smart card interface device and said smart card of the first type.

To reach the third object, the present invention provides a method of sending data from a handheld device by using an expansion slot of said handheld device characterized by comprising the steps of:

generating serial communication data signals and clock signals within said handheld device;

driving I/O ports included in said expansion slot of said handheld device;

sending said data signals and clock signals to said I/O ports according to a predetermined protocol.

To reach the fourth object, the present invention provides a method of receiving data from a handheld device by using an expansion slot of said handheld device, characterized by comprising the steps of:

receiving serial communication data signals and clock signals from I/O ports included in said expansion slot of said handheld device;

translating said data signals and clock signals into data according to a predetermined protocol.

To reach the fifth object, the present invention provides a method of controlling the power supply of a smart card interface device within a handheld device, characterized by comprising the steps of:

switching on said smart card interface device before a smart card is accessed; and

switching off said smart card interface device after a smart card is accessed.

According to the present invention, a smart card enabled handheld device will provide different kinds of new functionality that is only originally provided by smart cards by installing different kinds of smart card in the expansion slot of said handheld device. Therefore the application field of the handheld devices will be greatly expanded.

The following sections will give the detailed implementation of the present invention with reference to the attached drawings. The characteristics and the advantages of the present invention will be more obvious from this description. Among these drawings,

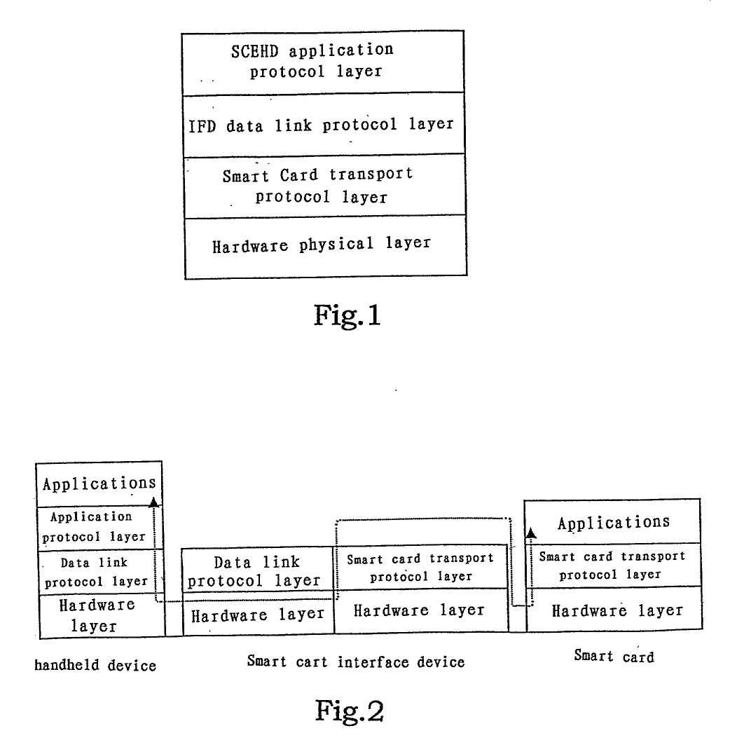

FIG. 1 is the logical infrastructure of the smart card enabled handheld device;

FIG. 2 is the data flow diagram between the handheld device and the smart card;

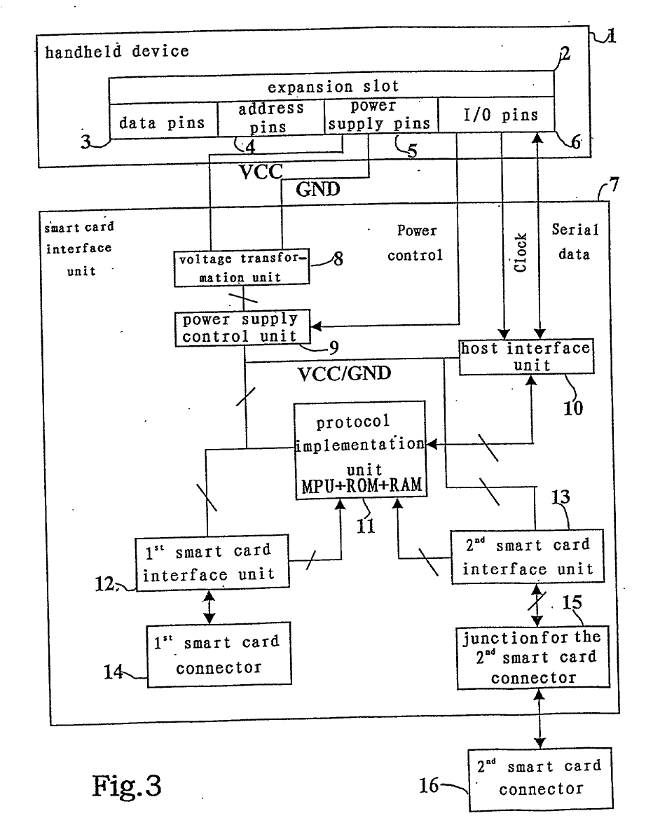

FIG. 3 is the hardware infrastructure of said smart card interface device.

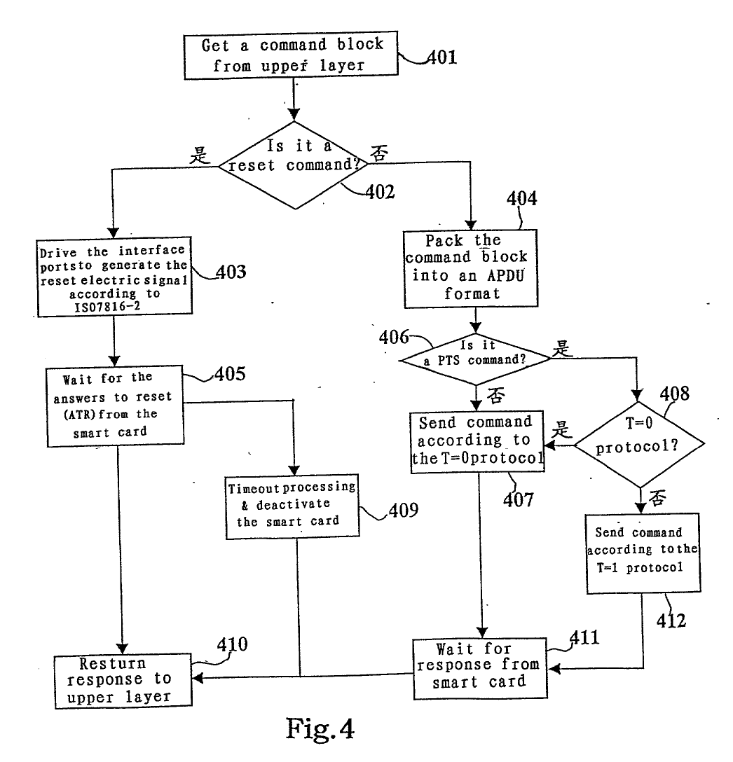

FIG. 4 is the software flowchart of the smart card data transport protocol layer.

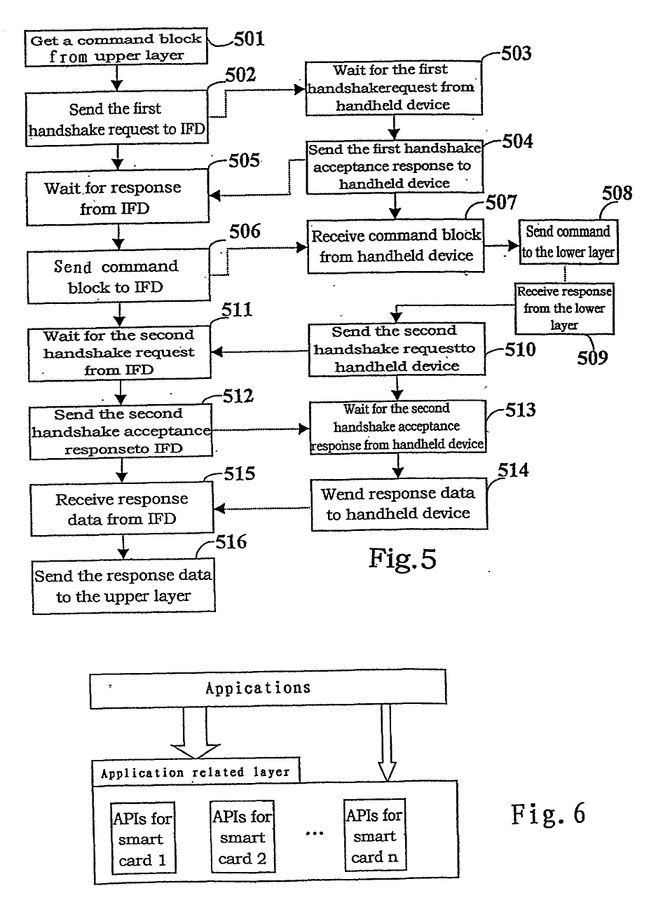

FIG. 5 is the software flowchart of the data link protocol layer of the smart card interface device.

FIG. 6 is the infrastructure of the application protocol layer.

The preferred embodiments of the present invention will be described with reference to the attached drawings as follows.

The basic idea of the present invention is to design a smart card interface device through which the handheld device can connect a smart card of the first type and/or a smart card of the second type. This smart card of the first type is the smart card with smaller size, namely SIM card. The smart card of the second type is the smart card with any other size (same as a credit card in general). This smart card interface device can be installed in the expansion slot of the handheld device so as to setup the electric connection between the handheld device and the smart card. In addition, software was designed for both the handheld device and the smart card interface device so as to support the data transmission between the handheld device and the smart card interface device. In the present invention, the handheld device with the smart card interface device and the software is defined as the smart card enabled handheld device (SCEHD).

FIG. 1 shows the logical infrastructure of the smart card enabled handheld device, which is a layered structure, comprising:

a hardware physical layer, managing the hardware channel between the handheld device and the smart card interface device, and the hardware channel between the smart card interface device and the smart card.

a smart card transport protocol layer, providing a reliable data transfer channel between the smart card interface device and the smart card.

an IFD data link protocol layer, providing a reliable data transfer channel between the handheld device and the smart card interface device.

a SCEHD application protocol layer, providing an universal Application programming interface(API) for the developers to develop higher-level applications or higher-level protocols for handheld devices. These applications or higher-level protocols run on top of the SCEHD application protocol layer so that they can use smart card to support typical application tasks, such as, the tasks of protecting the handheld device itself and/or the data transferred between the handheld device and the remote server from malicious attack.

FIG. 2 shows the data flow diagram between the handheld device and the smart card. As shown in FIG. 2, data flows among three devices (the handheld device, the smart card interface device and the smart card). In each device, the lower-level layer provides the support for the higher-level layer, and the hardware layer is the base of each device. The data transfer between the handheld device and the smart card interface device relates to the data link protocol layer and the hardware layer. The data transfer between the smart card interface device and the smart card relates to the smart card data transport protocol layer and the hardware layer.

The following section will give the detailed description about the hardware layer. The hardware physical layer provides the hardware interface between the handheld device and the smart card. It's implemented as an embedded smart card interface device for the handheld device in the present invention, used to transfer the electric signals between the handheld device and the smart card.

Most of the existing handheld devices have an expansion slot to support the third party's hardware products. The smart card interface device introduced in the present invention is a hardware card that can be installed in an expansion slot of a handheld device. FIG. 3 shows the hardware infrastructure of the smart card interface device.

As shown in FIG. 3, the handheld device 1 has an expansion slot 2 . The expansion slot 2 contains data pins 3 , address pins 4 , power supply pins 5 and I/O pins 6 . The smart card interface device 7 comprises a voltage transformation unit 8 , a power supply control unit 9 , a host interface unit 10 , a protocol implementation unit 11 , a first smart card interface unit 12 , a second smart card interface unit 13 , a first smart card connector 14 and a second smart card cable junction. A second smart card connector 16 positioned at the outside of the smart card interface device 7 can connect with the second smart card cable junction 15 .

The voltage transformation unit 8 connects with the power supply pins 5 of the expansion slot 2 , gets power from said power supply pins to supply each component of the smart card interface device 7 with power. The working voltage of almost all the handheld devices is 3.3v , while the standard working voltage for a smart card is 5v . Therefore the voltage transformation unit 8 is used to get power from the handheld device and convert the power voltage into a working voltage of the smart card for example, 5v

The power supply control unit 9 is designed for the purpose of power saving. Its used to control selectively the power supply for the whole smart card interface device and the smart card. The power supply control unit 9 acts as a toggle in response to high or low state of the I/O pins 6 . For example, the power supply control unit starts supplying power when the signal coming from the I/O pins 6 is high, while the power supply control unit stops supplying power when the signals coming from the I/O pins 6 is low.

The above implementation is only an example of the power supply control unit 9 . The voltage transformation unit 8 and the power supply control unit 9 may have any other implementation to reach the purpose of power saving.

The host interface unit 10 is used to provide a reliable physical channel between the protocol implementation unit 11 in fact the microprocessor in the protocol implementation unit 11 and the handheld device to satisfy the requirement of data transmission between both sides. Limited by the hardware resource, the hardware interface capability for the add-on I/O devices of most handheld devices is rather simple. This makes the design for the add-on I/O devices of the handheld devices more difficult. In the present invention, we introduce a very simple and flexible method to address this problem, which uses two parallel I/O ports to simulate a standard I2C serial bus by using software method. This method will provide a synchronous data transmission between the handheld device 1 and the smart card interface device 7 by using only two parallel I/O ports.

The protocol implementation unit 11 comprises three parts in functionality: the microprocessor, the read-only memory and the random-access memory. The read-only memory is used to hold the programs engaged in three key tasks of: managing the whole smart card interface device, implementing the communication protocol between the smart card interface device and the smart card, and implementing the communication protocol between the handheld device and the smart card interface device. The microprocessor is the control core of the smart card interface device. It makes the separate units of the smart card interface device work cooperatively with each other by executing the programs held in the read-only memory. It also acts as a bridge to connect the handheld device with the smart card. The random-access memory is used as a data buffer and provides an executing environment for running the programs.

The first smart card interface unit 12 is used to provide a reliable electric channel between the microprocessor of the protocol implementation unit 11 and the smart card. This unit can be divided into two separate parts. The first part is the smart card detecting circuit that is used to detect whether a smart card of the first type has been connected to the first smart card connector 14, to monitor the state of said smart card and to generate an interrupt to the microprocessor when a short circuit or an under voltage condition occurs. The second part is the smart card driving circuit that is used to supply the smart card with power and provide the data transfer between the smart card and the microprocessor of the smart card protocol implementation unit 11

The first smart card connector 14 is mounted at a surface of the smart card interface device 7. Its a SIM card connector of smaller dimension. This configuration makes it possible to install both the first smart card and the smart card interface device inside the handheld device without losing the mobility of the handheld device.

Sometimes there may be the requirement for two smart cards to work simultaneously. In this case, more than one smart card connector like the first smart card connector 14 and more than one smart card interface unit like the first smart interface unit 12 can be installed at a surface of the smart card interface device 7 if there's enough space. In this card, accordingly, the program held in the read-only memory of the protocol implementation unit 11 need to be modified correspondingly.

Sometimes there may be the requirement of using the smart cart with normal size, namely the second smart card. In this case, its impossible to install the second smart card inside the handheld device due to larger size of the second smart card. To address the problem, a second smart card interface unit 13 and a second smart card cable junction 15 is mounted at a surface of the smart card interface device 7 , as illustrated in FIG. 3.

The second smart card interface unit 13 acts in the same way as the first smart card interface unit 12. It is unnecessary to give more details.

Sometimes its difficult to install two smart card connectors on the surfaces of the smart card interface device 7 due to the space limitation, so a second smart card cable junction 15 is installed at a surface of the smart card interface device 7 . This design makes it possible to connect an external second smart card connector 16 to the second smart card cable junction 15 so as to connect to the second smart card interface unit 13 . The second smart card connector may be positioned anywhere outside the handheld device.

The smart card interface device shown in FIG. 3 will provide the following characteristics:

1) To support any smart cards that are compatible with the ISO7816 specification and most memory cards, such as SLE4432, SLE4442, AT45D041, AT24C64, etc.

2) To support two smart cards working either simultaneously or individually. There's a SIM card connector and a cable junction at the surface of the smart card interface device. The SIM card connector is used to hold a SIM card and the cable junction is used to connect with an external smart card connector.

3) To have low power consumption. As the batteries of the handheld device supply the smart card interface device with power, the power consumption of the smart card interface device is very important for the handheld device. To extend the batteries life, a power supply control unit is installed in the smart card interface device. The power supply control unit can control the process of the power-on and the power-off for the whole smart card interface device and for the smart card as well by using software method will consume power only when it wants to operate the smart card.

4) To have data transport protocol defined in ISO/IEC7816-3 implemented by the smart card interface device totally. The CPU power of most handheld devices is usually very poor. The present invention uses the microprocessor of the smart card interface device to implement the data transport protocol, which decrease the overload of the CPU of the handheld device greatly.

5) To support multiple data transfer speed, up to 56 KBPS.

FIG. 4 shows the software flowchart of the smart card data transport protocol layer. The smart card data transfer transport protocol is used to implement the transport protocol defined in the ISO-7816-3,4. It's implemented as a program held in the read-only memory of the protocol implementation unit 11 of the smart card interface device 7. The microprocessor of the smart card interface device 7 reads or writes a wide variety of smart cards that are compatible with the ISO-7816 specification by executing this program.

ISO7816-3 specification defines two different types of transport protocol for smart card, the synchronous transport protocol suitable for the memory card and the asynchronous transport protocol(T=0,T=1) suitable for the asynchronous smart card. Smart card interface device 7 supports both types of the protocols. FIG. 4 shows the implementation of the asynchronous protocol as an example.

As shown in FIG. 4, the step 401 gets a command block from a higher-level layer. The step 402 then judges whether this command is a reset command. If yes, then it performs the step 403, if not, then it performs the step 404. The step 403 drives the interface ports to generate the electric reset signals according to ISO7816-2. Then the step 405 waits for the answer to reset(ATR) from the smart card. If an ATR is received, then it proceeds to the step 410, otherwise it performs the step 409 to do the process for the time out and deactivate the smart card. The step 410 is used to return the response to the higher-level layer.

The step 404 packs the received command block into an APDU format. The step 406 then judges whether the command is a PTS. If yes, then it performs the step 408, otherwise it performs the step 407. The step 407 sends the command according to the T=0 protocol, then the step 411 waits for the response from the smart card, then it enters the step 410.

The step 408 judges whether the desired data transport protocol is the T=0 protocol. If yes, then it performs the step 407, otherwise it performs the step 412. The step 412 sends the command according to the T=1 protocol and then it proceeds to the step 411.

FIG. 5 shows the software flowchart of the data link protocol layer of the smart card interface device. The data link protocol layer of the smart card interface device provides a reliable data transfer channel between the handheld device 1 and the smart card interface device 7 . Its implemented as two separate programs running on the handheld device 1 and on the smart card interface device 7 respectively. A twice handshake protocol is used here to protect the data transferred from being lost. The smart card interface device 7 works in a command/response style. A handshake process should be taken before the handheld device 1 sends(receives) a command(response) to (from) the smart card interface device 7 to ensure that they know each other and the data link is reliable. FIG. 5 shows this twice handshake process between the handheld device and the smart card interface device.

As shown in FIG. 5, the steps 501, 502, 505, 506, 511, 512, 515 and 516 are performed on the handheld device 1, and the steps 503, 504, 507, 510,5 13 and 514 are performed on the smart card interface device 7. While the steps 508 and 509 are performed on the smart card. The dashed lines in the FIG. 5 illustrate the process of the data transmission. The following section will give a description of this process following these dashed lines.

The step 501 gets a command block from a higher-level layer.

The step 502 sends the first handshake request to the smart card interface device.

The step 503 waits for the first handshake request from the handheld device.

The step 504 sends the response of the first handshake acceptance to the handheld device.

The step 505 waits for the response from the smart card interface device.

The step 506 sends the command block to the smart card interface device.

The step 507 receives the command block from the handheld device.

The step 508 sends the command to the lower-level layer.

The step 509 receives the command from the lower-level layer.

The step 510 sends the second handshake request to the handheld device.

The step 511 waits for the second handshake request form the smart card interface device.

The step 512 sends the response of the second handshake acceptance to the smart card interface device.

The step 513 waits for the second handshake response from the handheld device.

The step 514 sends the response data to the handheld device.

The step 515 receives the response data from the smart card interface device.

The step 516 sends the response data to the higher-level layer.

FIG. 6 shows the infrastructure of the application protocol layer of the smart card enabled handheld device. This layer is used to provide the higher-level applications an universal application programming interface(API) with two main benefits:

1) Higher-level access to common functions provided by the smart card, such as cryptographic function.

2) Security related applications don't need their own cryptographic code; developers don't need to learn the details of the cryptographic functions and the smart card.

An important benefit of isolating applications from the details of the services provided by the smart card is that applications can get renewable, replaceable services provided by different type of smart card without changing the application. Another benefit is that the security related applications don't need implement any cryptographic algorithms that are provided by smart card now.

The application protocol layer comprises two sub-layers: the smart card related layer and the applications related layer.

The smart card related layer defines and provides the APIs used to manipulate individual smart cards directly. As different types of smart card may have different command sets or different command formats, so, different API sets may be provided for different types of smart card. This sub-layer gives the experienced developers the opportunity to manipulate the smart card more flexibly. For example, using the API Ld_sendcmd(unsigned char cmd, unsigned char sendlen, unsigned char* sendbuf, unsigned char* retcode, unsigned char * recvlen, unsigned char* recvbuf), developers can send a low-level command to the smart card and get a response from the smart card after it completes this command.

The applications related sub-layer masks the difference between different API sets within the smart card related layer and the details of the smart card, provides the developers a more universal applications related interface. For example, developers can encrypt a block of data by calling the API DESEncryption(unsigned char sendlen, unsigned char * sendbuf, unsigned char* recvlen, unsigned char * recvbuf) without knowing which type of smart card is used.

An application can call the APIs within the smart card related layer or the APIs within the applications related layer separately, or call both of them concurrently, as illustrated in FIG. 6.

Lets look back at the FIG. 3, the present invention provides two methods for data transmission between the handheld device(1) and the smart card interface device(7).

The first method is used for sending data from a handheld device by using an expansion slot of said handheld device, characterized by comprising the steps of:

generating serial communication data signals and clock signals within said handheld device;

driving I/O ports included in said expansion slot of said handheld device (i.e. I/O pin 6);

sending said data signals and clock signals to said I/O ports according to a predetermined protocol (e.g. ISO 7816-3, 4).

The second method is used for receiving data from a handheld device (1) by using an expansion slot (2) of said handheld device (1) characterized by comprising the steps of:

receiving serial communication data signals and clock signals from I/O ports included in said expansion slot (2) of said handheld device (i.e. I/O pin 6);

transforming said data signals and clock signals into data according to a predetermined protocol (e.g. ISO7816-3,4)

The data transferred may be the command/response pair illustrated in FIG. 5 and so on.

In addition, the implementation of the smart card interface device relates to a method of controlling the power supply of a smart card interface device within a handheld device, characterized by comprising the steps of:

switching on said smart card interface device (7) before a smart card is accessed; and

switching off said smart card interface device (7) after a smart card is accessed.

Although the previous sections give the detailed implementation of the present invention with the attached drawings, its still possible for the skilled in the art to make some changes or modifications without departing from the range and spirit of the present invention. Therefore the range of the present invention is covered only by the appended claims of the present invention.

What is claimed is:

1. A smart card interface device which can be installed in an expansion slot of a handheld device, characterized by comprising:
a host interface unit for connecting with I/O ports included in the expansion slot of the handheld device so as to receive/send serial communication data signals and clock signals from/to said I/O ports;
a first smart card connector provided at a surface of said smart card interface device, used for electrically connecting with a smart card of the first type;
a first smart card interface unit for detecting whether a smart card of the first type has been connected to said first smart card connector and for driving the smart card of the first type being connected;
a protocol implementation unit for controlling each component of said smart card interface device so as to implement communication protocols between said smart card interface device and said handheld device as well as communication protocols between said smart card interface device and said smart card of the first type.

2. The smart card interface device according to claim 1, characterized in that said protocol implementation unit comprises:
a microprocessor;
a read only memory which stores programs executed by said microprocessor, said programs being used for controlling each component of said smart card interface device so as to implement communication protocols between said smart card interface device and said handheld device as well as communication protocols between said smart card interface device and said smart card of the first type;
a random access memory serving as a data buffer and an execution environment for said programs.

3. The smart card interface device according to claim 1, characterized by further comprising:
a voltage transformation unit used for connecting with power pins included in the expansion slot of the handheld device, getting power from said power supply pins and converting the power voltage into a working voltage of the smart card.

4. The smart card interface device according to claim 3, characterized by further comprising:
a power supply control unit used for connecting with I/O ports included in the expansion slot of the handheld device, and controlling output voltage of said voltage transformation unit in response to high or low state of signals from said I/O ports.

5. The smart card interface device according to any one of claims 1 to 4, characterized by further comprising:
a junction for a second smart card connector, provided on a surface of said smart card interface device, used for connecting with a second smart card connector positioned external to said smart card interface device, said second smart card connector being used for electrically connecting with a smart card of the second type;
a second smart card interface unit for detecting whether a smart card of the second type has been connected to said junction for a second smart card connector via a second smart card connector and for driving the smart card of the second type being connected;
said protocol implementation unit being also used for implementing communication protocols between said smart card interface device and said smart card of the second type.

6. A handheld device having an expansion slot which includes I/O ports, said handheld device characterized by comprising:
means for driving said I/O ports;
means for sending/receiving serial communication data signals and clock signals to/from said I/O ports;
a smart card interface device connected to said expansion slot comprising:
a host interface unit connected to said I/O ports, for receiving/sending serial communication data signals and clock signals from/to said I/O ports;
a first smart card connector provided at a surface of said smart card interface device, for electrically connecting with a smart card of the first type;
a first smart card interface unit for detecting whether a smart card of the first type has been connected to said first smart card connector and for driving the smart card of the first type being connected;
a protocol implementation unit for controlling each component of said smart card interface device so as to implement communication protocols between said smart card interface device and said handheld device as well as communication protocols between said smart card interface device and said smart card of the first type.

7. The handheld device according to claim 6, characterized in that said protocol implementation unit comprises:
a microprocessor;
a read only memory which stores programs executed by said microprocessor, said programs being used for controlling each component of said smart card interface device so as to implement communication protocols between said smart card interface device and said handheld device as well as communication protocols between said smart card interface device and said smart card of the first type;
a random access memory serving as a data buffer and an execution environment for said programs.

8. The handheld device according to claim 6, characterized in that said expansion slot includes power supply pins; and that said smart card interface device further comprises:
a voltage transformation unit connected to said power supply pins, for getting power from said power supply pins and converting the power voltage into a working voltage of the smart card.

9. The handheld device according to claim 8, characterized in that said smart card interface device further comprises:
a power supply control unit connected to said I/O ports, for controlling output voltage of said voltage transformation unit in response to high or low state of signals from said I/O ports.

10. The handheld device according to any one of claims 6 to 9, characterized in that said smart card interface device further comprises:
a junction for a second smart card connector, provided on a surface of said smart card interface device, used for connecting with a second smart card connector positioned external to said smart card interface device, said second smart card connector being used for electrically connecting with a smart card of the second type;
a second smart card interface unit for detecting whether a smart card of the second type has been connected to said junction for a second smart card connector via a second smart card connector and for driving the smart card of the second type being connected;
said protocol implementation unit being also used for implementing communication protocols between said smart card interface device and said smart card of the second type.

11. A method of sending data from a handheld device by using an expansion slot of said handheld device characterized by comprising the steps of:
generating serial communication data signals and clock signals within said handheld device;
driving I/O ports included in said expansion slot of said handheld device;
sending said data signals and clock signals to said I/O ports according to a predetermined protocol.

12. A method of receiving data from a handheld device by using an expansion slot of said handheld device characterized by comprising the steps of:
receiving serial communication data signals and clock signals from I/O ports included in said expansion slot of said handheld device;
translating said data signals and clock signals into data according to a predetermined protocol.

13. A method of controlling the power supply of a smart card interface device within a handheld device characterized by comprising the steps of:
switching on said smart card interface device before a smart card is accessed; and
switching off said smart card interface device after a smart card is accessed.
